(19) United States
(12) Patent Application Publication
(10) Pub. No.: US 2011/0268377 A1
(43) Pub. Date: Nov. 3, 2011

(54) SLIDING APPARATUS FOR ELECTRONIC DEVICE

(75) Inventor: WEN-BIN SHEN, Tu-Cheng (TW)

(73) Assignee: HON HAI PRECISION INDUSTRY CO., LTD., Tu-Cheng (TW)

(21) Appl. No.: 12/837,476

(22) Filed: Jul. 15, 2010

(30) Foreign Application Priority Data
Apr. 30, 2010 (TW) 99207913

(51) Int. Cl. F16F 1/06; F16F 1/12; F16C 29/02

(52) U.S. Cl. 384/37; 267/155

(57) ABSTRACT

A sliding apparatus includes a first sliding member and a second sliding member slidable relative to the first sliding member. A first resilient member and a second resilient member are connected between the first and second sliding members. The first and second resilient members overlap with each other to provide the better sense of damping for operators.

### CROSS-REFERENCE TO RELATED APPLICATION

Relevant subject matter is disclosed in co-pending U.S. patent application Ser. Nos. (Attorney Docket Nos. US30361 and US30362), both filed on the same date, entitled “SLIDING APPARATUS FOR ELECTRONIC DEVICE,” and assigned to the same assignee as named herein.

### BACKGROUND

1. Technical Field

The present disclosure relates to sliding apparatuses and, particularly to an apparatus used for an electronic device having a slidable display.

2. Description of Related Art

Usually, displays of electronic devices are slidable for convenient operation and to save space. For example, a mobile phone generally has a main body and a slidable display mounted to the main body by a sliding apparatus. The display slides to a predetermined position, by the sliding structure. A resilient member is always used in the sliding apparatus for adding sense of damping for operators. However, the elasticity of a traditional resilient member may be insufficient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an embodiment of a sliding apparatus, the sliding apparatus includes a first resilient member and a second resilient member.

FIG. 2 is an enlarged, isometric view of the first resilient member of FIG. 1.

FIG. 3 is a side view of FIG. 2.

FIG. 4 is an enlarged, isometric view of the second resilient member of the sliding apparatus of FIG. 1.

FIG. 5 is an isometric view of the first resilient member overlapping with the second resilient member of FIG. 1.

FIG. 6 is a side view of FIG. 5.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

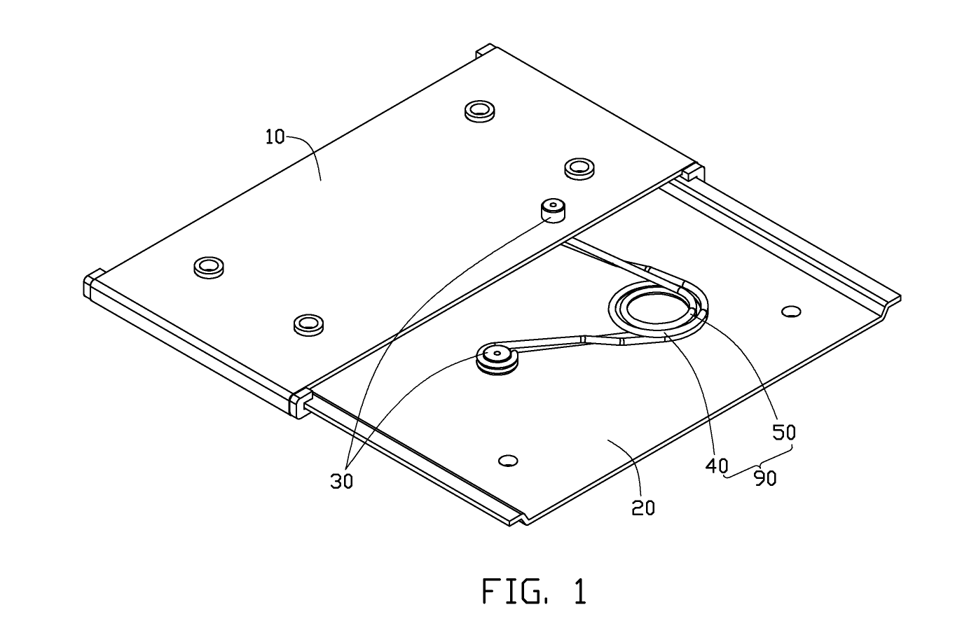

Referring to FIG. 1, an exemplary embodiment of a sliding apparatus includes a first sliding member 10, a second sliding member 20, two fasteners 30, and a resilient assembly 90 including a first resilient member 40 and a second resilient member 50.

The second sliding member 20 is slidably attached to the first sliding member 10. The fasteners 30 are fixed to the first sliding member 10 and the second sliding member 20, respectively. Each fastener 30 includes a column defining two parallel annular recessed portions (not shown) in a circumference of the fastener 30.

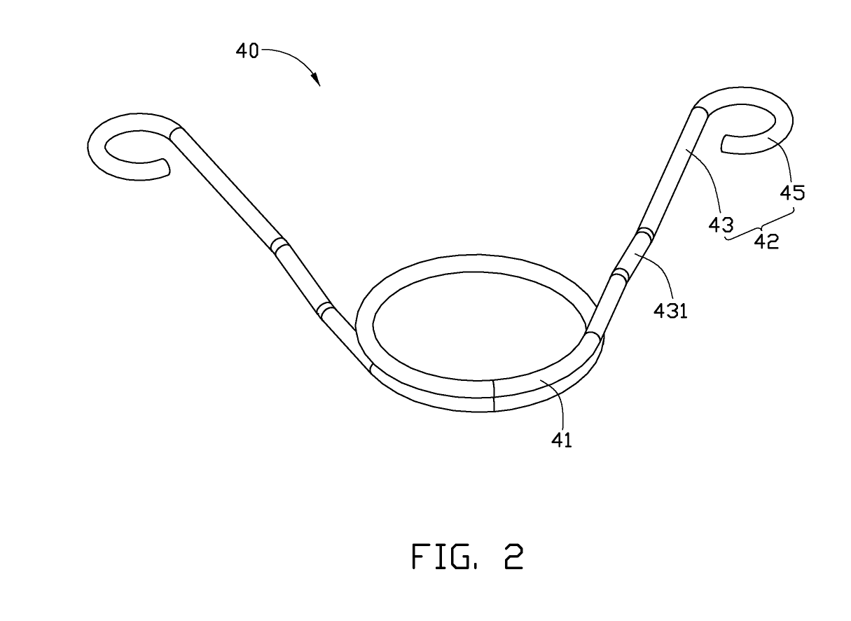

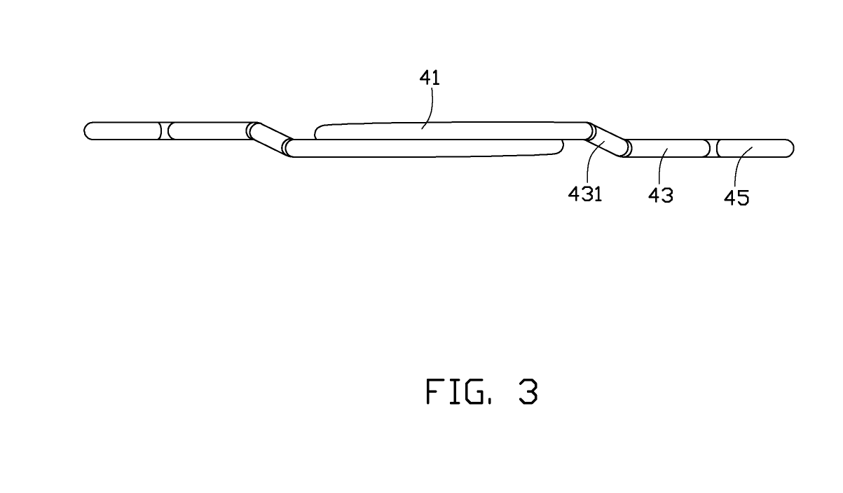

Referring to FIGS. 2 and 3, the first resilient member 40 is a torsion spring and includes a coil portion 41 at a middle portion and two first feet 42 extending from opposite ends of the coil portion 41 respectively. Each first foot 42 includes a pole 43 and a C-shaped clip 45 formed at a distal end of the pole 43. Each pole 43 includes a bent portion 431 at a middle portion of the pole 43. One of the bent portions 431 slantingly extends up to raise the distal end of the corresponding pole 43. The other bent portion 431 slantingly extends down to depress the distal end of the corresponding pole 43.

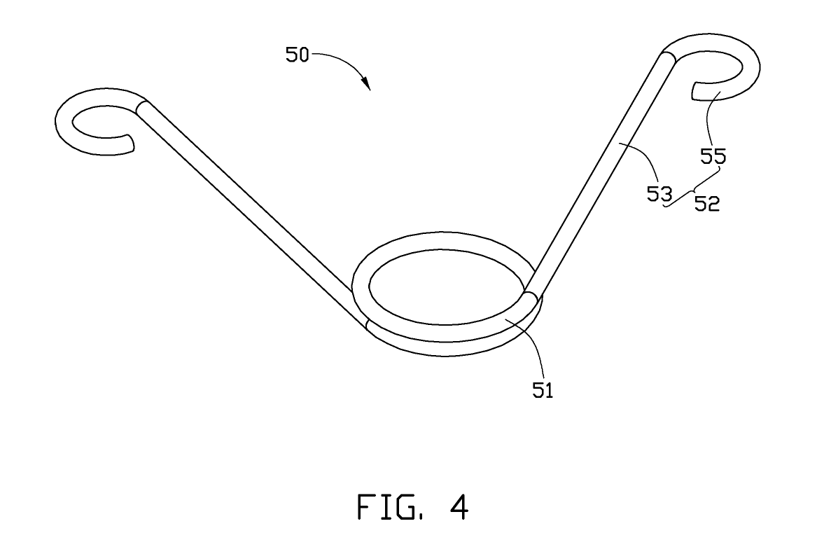

Referring to FIG. 4, the second resilient member 50 is a torsion spring and includes a coil portion 51 at a middle portion and two second feet 52 extending from opposite ends of the coil portion 51 respectively. Each second foot 52 includes a pole 53 and a C-shaped clip 55 formed at a distal end of the pole 53. The outside diameter of the coil portion 51 is smaller than the inside diameter of the coil portion 41.

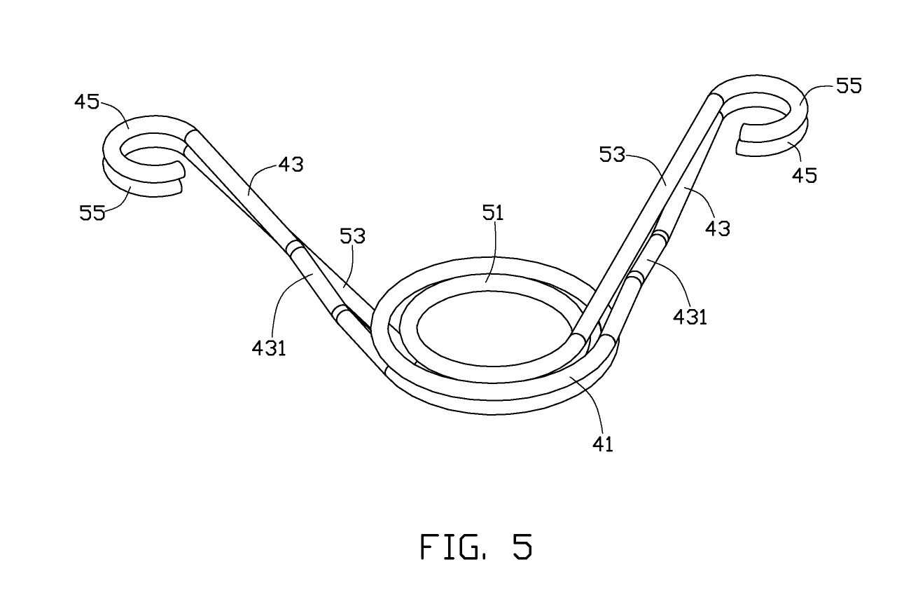

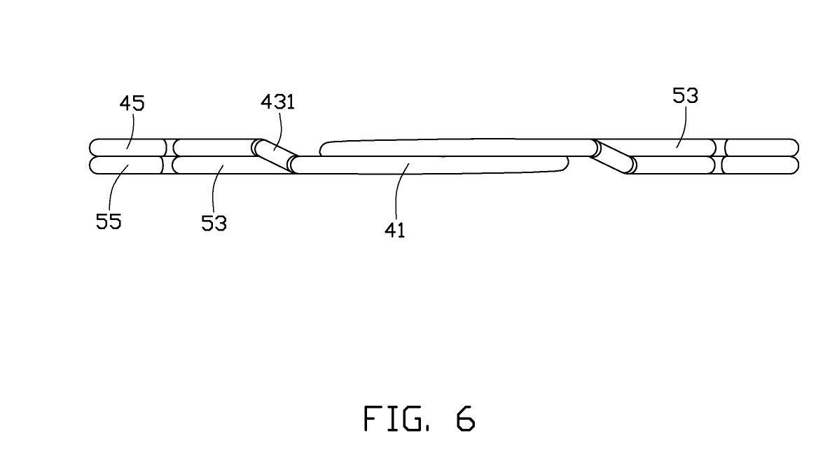

Referring to FIGS. 5 and 6, in assembly, one second foot 52 of the second resilient member 50 extends through the coil portion 41, to position the coil portion 51 of the second resilient member 50 in the coil portion 41 of the first resilient member 40.

The first feet 42 of the first resilient member 40 overlap with the corresponding second feet 52 of the second resilient member 50. One first foot 42 of the first resilient member 40 with the bent portion 431 extending up is arranged above the corresponding second foot 52 of the second resilient member 50, with the bent portion 431 crossing with the corresponding pole 53. The opposite first foot 42 of the first resilient member 40 with the bent portion 431 extending down is arranged below the corresponding second foot 52 of the second resilient member 50, with the bent portion 431 crossing with the corresponding pole 53. The clips 45 and 55 of one side of the resilient assembly 90 are positioned about the recessed portions of the fastener 30 mounted to the first sliding member 10. The clips 45 and 55 of the opposite side of the resilient assembly 90 are positioned about the recessed portions of the fastener 30 mounted to the second sliding member 20.

When the second sliding member 20 is slid relative to the first sliding member 10, an operator should provide more force against the resilient assembly 90 including the first resilient member 40 and the second resilient member 50. Thus the sliding apparatus provides the better sense of damping for operators.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A sliding apparatus comprising:
a first sliding member;
a second sliding member slidably attached to the first sliding member;
a first torsion spring connected between the first and second sliding members, the first torsion spring comprising a first coil portion at a middle portion and two first feet extending from opposite ends of the first coil portion respectively, each first foot comprises a bent portion at a middle portion of the first foot; and
a second torsion spring connected between the first and second sliding members, the second torsion spring comprising a second coil portion at a middle portion and two second feet extending from opposite ends of the second coil portion respectively;
wherein the outside diameter of the second coil portion of the second torsion spring is smaller than the inside diameter of the first coil portion of the first torsion spring, one second foot of the second torsion spring extends through the first coil portion of the first torsion spring to position the second coil portion of the second torsion spring in the first coil portion of the first torsion spring, the first feet of the first torsion spring overlap with the corresponding second feet of the second torsion; and
wherein one first foot of the first resilient member is arranged above the corresponding second foot of the second resilient member, with the corresponding bent portion crossing with the corresponding second foot, the other first foot of the first resilient member is arranged below the corresponding second foot of the second resilient member, with the corresponding bent portion crossing with the corresponding second foot.

2. The sliding apparatus of claim 1, wherein one of the bent portions slantingly extends up to raise the distal end of the corresponding first foot, the other bent portion slantingly extends down to depress the distal end of the corresponding first foot.

3. The sliding apparatus of claim 1, wherein each first foot of the first torsion spring comprises a pole and a clip formed at a distal end of the pole, the bent portion is formed at a middle of the pole, the clips of the first torsion spring are fixed to the first sliding member and the second sliding member by two fasteners, respectively.

4. The sliding apparatus of claim 1, wherein each second foot of the second torsion spring comprises a pole and a clip formed at a distal end of the pole, the clips of the second torsion spring are fixed to the first sliding member and the second sliding member by two fasteners respectively.

5. The sliding apparatus of claim 1, further comprising two fasteners fixed to the first sliding member and the second sliding member respectively, wherein two opposite feet of each of the first torsion spring and second torsion spring are fixed to the fasteners, respectively.

6. A resilient assembly comprising:
a first torsion spring comprising a first coil portion at a middle portion and two first feet extending from opposite ends of the first coil portion respectively, each first foot comprises a bent portion at a middle portion of the first foot; and
a second torsion spring comprising a second coil portion at a middle portion and two second feet extending from opposite ends of the second coil portion respectively;
wherein the outside diameter of the second coil portion of the second torsion spring is smaller than the inside diameter of the first coil portion of the first torsion spring, one second foot of the second torsion spring extends through the first coil portion of the first torsion spring to position the second coil portion of the second torsion spring in the first coil portion of the first torsion spring, the first feet of the first torsion spring overlap with the corresponding second feet of the second torsion; and
wherein one first foot of the first resilient member is arranged above the corresponding second foot of the second resilient member, with the corresponding bent portion crossing with the corresponding second foot, the other first foot of the first resilient member is arranged below the corresponding second foot of the second resilient member, with the corresponding bent portion crossing with the corresponding second foot.

7. The resilient assembly of claim 6, wherein one of the bent portions slantingly extends up to raise the distal end of the corresponding first foot, the other bent portion slantingly extends down to depress the distal end of the corresponding first foot.

8. The resilient assembly of claim 6, wherein each first foot of the first torsion spring comprises a pole and a clip formed at a distal end of the pole, the bent portion is formed at a middle of the pole.

9. The resilient assembly of claim 6, wherein each second foot of the second torsion spring comprises a pole and a clip formed at a distal end of the pole.
